(19) United States
(12) Patent Application Publication
(10) Pub. No.: US 2007/0130115 A1
(43) Pub. Date: Jun. 7, 2007

(54) OPTIMIZING A QUERY THAT INCLUDES A LARGE IN LIST

(76) Inventors: Grace Au, Rancho Palos Verdes, CA (US); Bhashyam Ramesh, Secunderabad (IN); Haiyan Chen, Yorktown Heights, NY (US)

Correspondence Address: JAMES M. STOVER;NCR CORPORATION, 1700 SOUTH PATTERSON BLVD, WHQ4, DAYTON, OH, 45479, US

(21) Appl. No.: 11/561,446

(22) Filed: Nov. 20, 2006

Related U.S. Application Data
(60) Provisional application No. 60/741,392, filed on Dec. 1, 2005.

(51) Int. Cl. G06F 17/30

(52) U.S. Cl. 707/2

(57) ABSTRACT

An optimization technique involves optimizing a SQL query, in which the SQL query includes a large IN-List query to access data in a table. The technique includes determining whether an IN-List exceeds a predetermined size, and, if so, removing the IN-List query statement and inserting a new query statement including a join operation.

### BACKGROUND

Relational database systems store data in tables organized by columns and rows. The tables typically are linked together by “relationships” that simplify the storage of data and make complex queries against the database more efficient. Structured Query Language (or SQL) is a standardized language for creating and operating on relational databases.

A relational database system typically includes an “optimizer” that plans the execution of SQL queries. For example, if a query requires accessing or “joining” more than two tables, the optimizer will select the order that the tables are joined to produce the requested result in the shortest period of time or to satisfy some other criteria.

Many tools are available to assist a database administrator in forming a query. However, tool generated queries commonly create IN-Lists with thousands values. Such large IN-Lists present challenges in terms of performance improvement and memory consumption.

Where there are a large number of elements in an IN-List and each row of a large table needs to be evaluated against every condition in the IN-List, the intensive comparison performed by the CPU can result in poor performance. In some cases an IN-List may be so large that the maximum allowable amount of memory and stack space available to process the query is exceeded, resulting in the query being terminated prematurely.

### SUMMARY

An optimization technique is provided that allows the use of, and improves the performance of, a large IN-List query. This is accomplished, for example, by recognizing a large IN-List query, and modifying the IN-List utilising a join technique. Modifying the IN-List prevents the generation of a large list of qualification conditions.

In general, in one aspect, the invention features a method for optimizing a SQL query, in which the SQL query includes a large IN-List query to access data in a table, where the method includes determining whether the size of the IN-List exceeds a predetermined size, and if so; removing the IN-List query statement; and inserting a statement to join the IN-List with the table inserting a query which utilizes a join operation.

Implementations of the invention may include one or more of the following. The method may include determining whether the IN-List query statement is located within a WHERE clause, and if so, adding a join between the IN-List and the table, and replacing the IN List with a join condition in the WHERE clause. The method may also include determining whether the clause is an ON clause, and if so determining whether the join is to an inner table. If so, a join condition is inserted between the inner table and the IN-List query. The method may also include determining if the join is to an outer table, and if so, replacing the IN-List with the new join condition. The method may also include determining if no WHERE or ON clause exists, and if so placing the IN-List in a spool so as to join the spool with the table.

In general, in another aspect, the invention features a database system for accessing a database. The database system includes a massively parallel processing system, which includes one or more nodes, a plurality of CPUs, each of the one or more nodes providing access to one or more CPUs, a plurality of virtual processes each of the one or more CPUs providing access to one or more processes, each process configured to manage data stored in one of a plurality of data-storage facilities; and an optimizer for optimizing a plan for executing a query. The query includes determining whether the size of the IN List exceeds a predetermined size, and if so, removing the IN List query statement and inserting a statement to join the IN-List with the table utilizing a join operation.

In general, in another aspect, the invention features a computer program, stored on a tangible storage medium, for use in optimizing a query including a large IN-List. The program includes executable instructions that cause a computer to determine whether the size of the IN-List exceeds a predetermined size. If so, the IN-List query statement is removed and a statement is inserted to join the IN-List with the table utilizing a join operation.

Other features and advantages will become apparent from the description and claims that follow.

### BRIEF DESCRIPTION OF THE DRAWINGS

FIG. 1 is a block diagram of a node of a database system.

FIG. 2 is a block diagram of a parsing engine.

FIG. 3 is a flow chart of a parser.

FIG. 4 is a flow chart of a technique for modifying a query which includes a large IN-List.

FIG. 5 is a flow chart of a technique for optimizing a query which includes a large IN-List.

### DETAILED DESCRIPTION

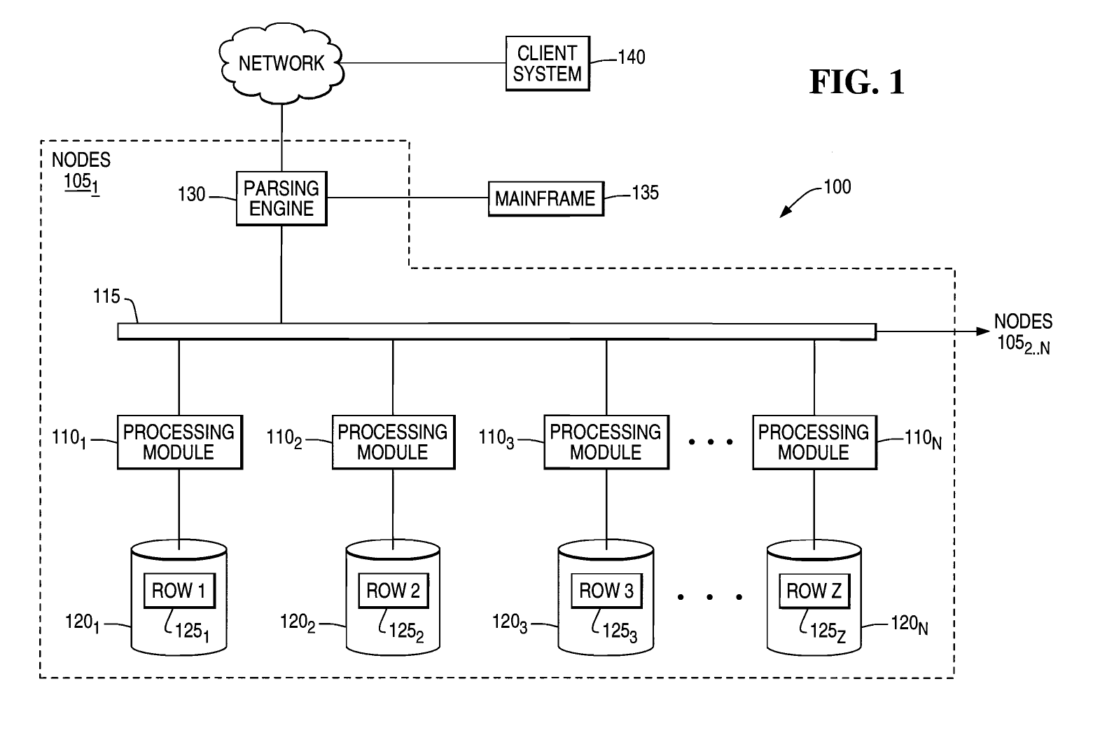

The query optimization technique disclosed herein has particular application to large databases that might contain many millions or billions of records managed by a database system (“DBS”) 100, such as a Teradata Active Data Warehousing System available from NCR Corporation. FIG. 1 shows a sample architecture for one node 105₁ of the DBS 100. The DBS node 105₁ includes one or more processing modules 110_{1 . . . N}, connected by a network 115 that manage the storage and retrieval of data in data-storage facilities 120_{1 . . . N}. Each of the processing modules 110_{1 . . . N} may be one or more physical processors or each may be a virtual processor, with one or more virtual processors running on one or more physical processors.

For the case in which one or more virtual processors are running on a single physical processor, the single physical processor swaps between the set of N virtual processors.

For the case in which N virtual processors are running on an M-processor node, the node's operating system schedules the N virtual processors to run on its set of M physical processors. If there are 4 virtual processors and 4 physical processors, then typically each virtual processor would run on its own physical processor. If there are 8 virtual processors and 4 physical processors, the operating system would schedule the 8 virtual processors against the 4 physical processors, in which case swapping of the virtual processors would occur.

Each of the processing modules 110_{1 . . . N} manages a portion of a database that is stored in a corresponding one of the data-storage facilities 120_{1 . . . N}. Each of the data-storage facilities 120_{1 . . . N} includes one or more disk drives. The DBS may include multiple nodes 105_{2 . . . N} in addition to the illustrated node 105₁, connected by extending the network 115.

The system stores data in one or more tables in the data-storage facilities 120_{1 . . . N}. The rows 125_{1 . . . Z} of the tables are stored across multiple data-storage facilities 120_{l . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data-storage facilities 120_{1 . . . N} in response to queries received from a user at a mainframe 135 or a client computer 140. The DBS 100 usually receives queries in a standard format, such as SQL.

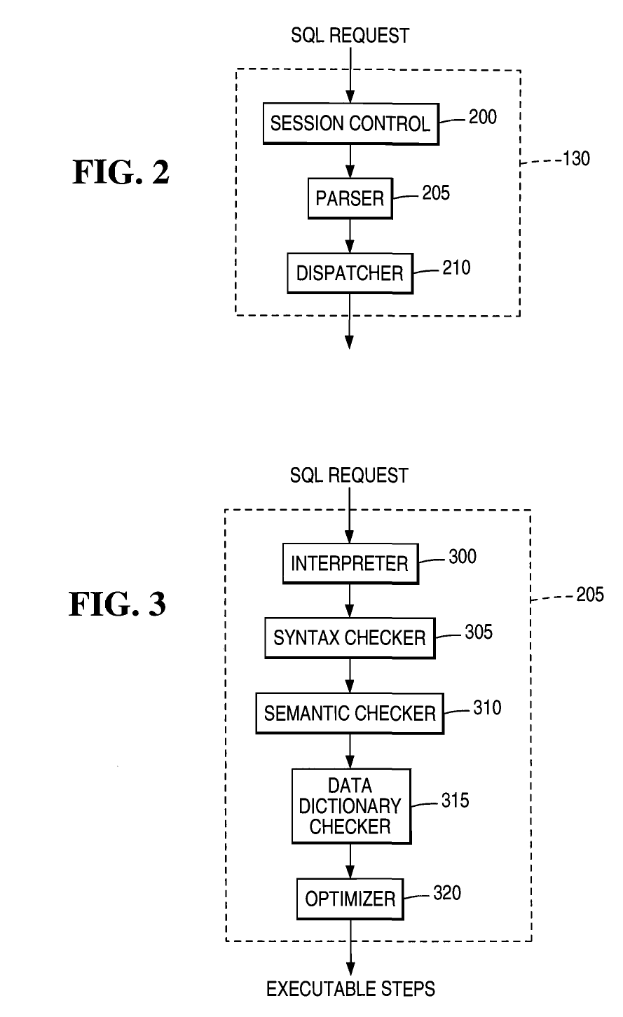

In one example system, the parsing engine 130 is made up of three components: a session control 200, a parser 205, and a dispatcher 210, as shown in FIG. 2. The session control 200 provides the logon and logoff function. It accepts a request for authorization to access the database, verifies it, and then either allows or disallows the access.

Once the session control 200 allows a session to begin, a user may submit a SQL request that is routed to the parser 205. As illustrated in FIG. 3, the parser 205 interprets the SQL request (block 300), checks it for proper SQL syntax (block 305), evaluates it semantically (block 310), and consults a data dictionary to ensure that all of the objects specified in the SQL request actually exist and that the user has the authority to perform the request (block 315). Finally, the parser 205 runs an optimizer (block 320) that develops the least expensive plan to perform the request.

The optimizer uses a technique to improve the performance of a query where large IN-Lists are defined. This includes modifying a IN-List defined on a non-index column, and increasing the system capability for handling IN-Lists with a large number of values. The technique used will depend on the type of IN-List encountered.

Where a sufficient quantity of system resources such as memory and stack space are available, the techniques of In-List Star Join (which is the subject of a U.S. Patent Application entitled “Optimizing Access to a Database by utilizing a Star Join” filed by NCR Corporation and which is incorporated herein by reference), and In-List access method (which is the subject of a US Patent Application entitled “Optimizing Access to a Database” filed by NCR Corporation and which is incorporated herein by reference), can be extended to be utilized on large IN-Lists defined on non-index columns to achieve better performance.

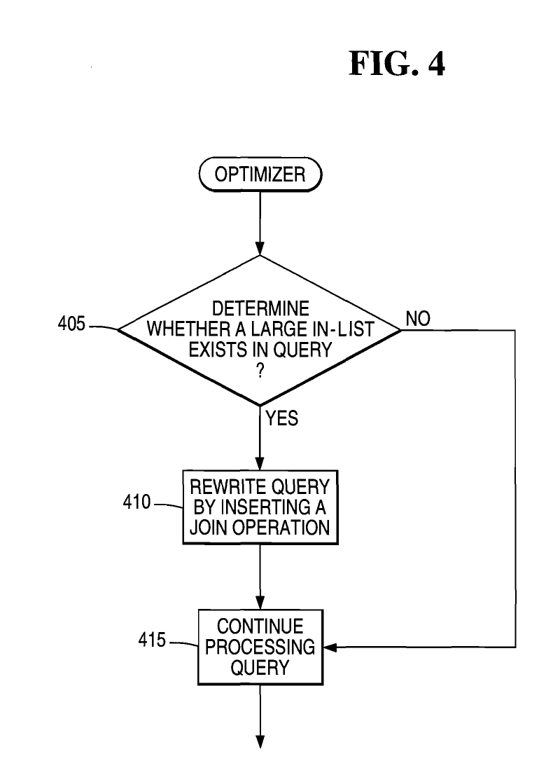

In some cases, an IN-List is so large that attempting to parse the query without modification would result in the optimizer exceeding the allocated system resources. Referring to FIG. 4, the optimizer 400 transforms the large IN-List into an IN-List relation during an early parsing stage of the query, by determining whether the IN-List within the query exceeds a predetermined size 405, and if so, rewriting the query with an appropriate join instruction 410, before continuing the parsing of the query 415.

The large list of conditions corresponding to the IN-List is replaced by a join condition between the IN-List relation and the relevant table. This results in a query which contains an extra join instruction but eliminates a large list of qualification conditions and therefore simplifies the parsing of the query. This technique is referred to as transforming IN-Lists into IN-List relations.

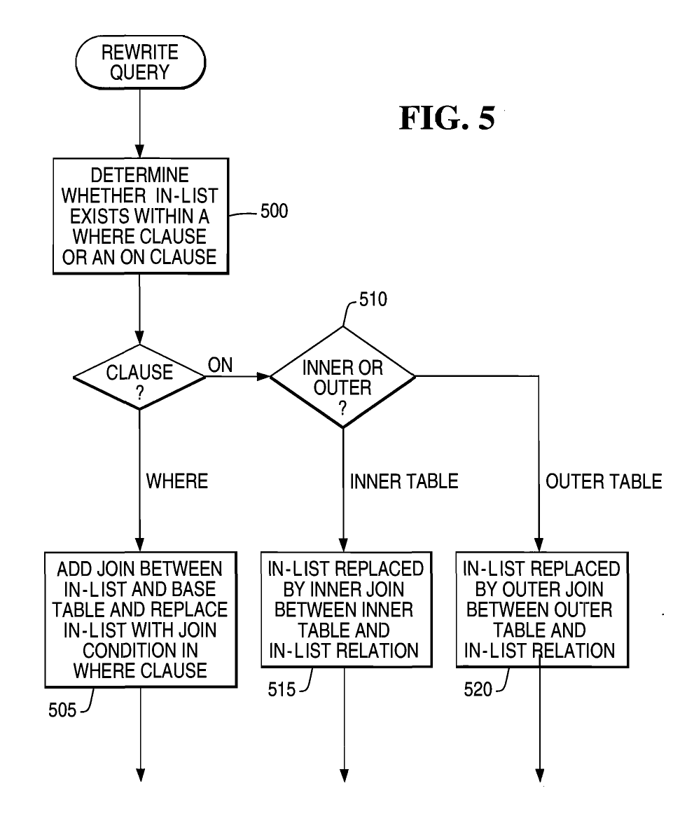

Referring to FIG. 5, the step of rewriting the query depends on whether the IN-List is located within a WHERE-clause or an ON-clause 500.

In the case where an IN-List is located within a WHERE-clause, the IN-List is transformed into an IN-List relation by adding a join between the IN-List relation and base table and replacing the IN-List with a join condition in the WHERE-clause 505 The algorithm works for subquery, derived table, view and outer join on the condition that the transformation is performed within a query block.

Two examples of IN-List queries and the manner in which they are re-written are illustrated below.

The first example query, as shown in the code fragment below, contains the IN-List in an outer block:

SEL SUM(sell_amt)

FROM daily_sales_tbl Sales , customer_tbl Cust
WHERE Sales.customer_id = Cust.customer_id AND

Sales.locn_nbr IN (1597, 1946, 1618, 1825)

NOT EXISTS ( SEL * FROM corp_day_tbl Prod

WHERE Sales.sku_id = Prod.sku_id

Prod.catg_nbr = 10 and Prod.dvsn nbr = 33 );

The first example query is re-written by the optimizer as follows, the changes being highlighted using bold text:

SEL SUM(sell_amt)

FROM daily_sales_tbl Sales ,

customer_tbl Cust,
inlist1

WHERE Sales.customer_id = Cust.customer_id AND

Sales.locn_nbr = inlist1. locn_nbr AND
NOT EXISTS ( SEL * FROM corp_day_tbl Prod

WHERE Sales.sku_id = Prod.sku_id AND

Prod.catg_nbr = 10 and
Prod.dvsn_nbr = 33);

The second example query, as shown below, contains the IN-List in an inner block:

SEL SUM(sell_amt)

FROM daily_sales_tbl Sales , customer_tbl Cust
WHERE Sales.customer_id = Cust.customer_id AND

NOT EXISTS (SEL * FROM corp_day_tbl Prod

WHERE Sales.sku_id = Prod.sku_id AND

Sales.locn_nbr IN (1597, 1946,

1618, 1825) AND

Prod.catg_nbr = 10 and
Prod.dvsn_nbr = 33);

The second example query is rewritten as follows, the changes being highlighted using bold text:

SEL SUM(sell_amt)

FROM daily_sales_tbl Sales , customer_tbl Cust
WHERE Sales.customer_id = Cust.customer_id AND
NOT EXISTS (SEL * FROM corp_day_tbl , inlist1

WHERE Sales.sku_id = Prod.sku_id AND
Sales.locn_nbr = inlist1. locn_nbr AND
Prod.catg_nbr = 10 and Prod.dvsn_nbr = 33);

An IN List may contain a null value. For example, a query may contain an IS NULL condition that is OR'ed with an IN predicate on the same column, as shown by the following example:

SEL SUM (sell_amt)

FROM daily_sales_tbl Sales, customer_tbl Cust
WHERE Sales.customer_id = Cust.customer_id AND

(Sales.locn_nbr IS NULL OR
Sales.locn_nbr IN (1597, 1946, 1618, 1825));

For an IN List that contains a null value, extra conditions are added to match the null value in the IN List relation with null values in the base table. For example, the above query is rewritten as:

SEL SUM(sell_amt)

FROM daily_sales_tbl Sales,

customer_tbl Cust, inlist1

WHERE Sales.customer_id = Cust.customer_id AND

(Sales.locn_nbr = inlist1. locn_nbr OR
Sales.locn_nbr IS NULL AND inlist1.locn_nbr IS NULL);

Referring again to FIG. 5, the technique may also be utilized for IN-Lists that appear within an ON-clause 510. For both left and right outer join operations, an IN-List within an ON-clause can generally be transformed into an IN-List relation by replacing the outer/inner table with a join between the outer/inner table and the IN-List relation.

In more detail, when the IN-List's base table is the inner table of the outer join, the IN predicate can be applied to qualify rows from the inner table before the outer join. In this case, the IN-List can be replaced by an inner join between the inner table and the IN-List relation 515. For example, for the relevant code fragment:

SEL SUM(sell_amt)

FROM daily_sales_tbl Sales Right Join corp_day_tbl Prod
ON Sales.locn_nbr IN (1597, . . ., 9456) AND

Sales.sku_id = Prod.sku_id;

The equivalent IN-List rewrite becomes (changes highlighted using bold text):

SEL SUM(sell_amt)

FROM (daily_sales_tbl Sales Inner Join inlist1
ON Sales.locn_nbr = inlist1.locn_nbr) Right Join
corp_day_tbl Prod
ON Sales.sku_id = Prod.sku_id;

When the IN-List's base table is the outer table, the IN predicate must be applied using an outer join so that any rows from the outer table which do not qualify will be output as un-matched rows. In this case, the IN List is replaced by an outer join between the outer table and the IN-List relation 520. Furthermore, the join condition of the original outer join is amended by an IS NOT NULL condition to preserve un-matching rows from the new outer join. For example, in the query below, replacing the IN-List with a new outer join and amending the join condition of the original outer join will achieve the desired outcome:

SEL SUM(sell_amt)

FROM daily_sales_tbl Sales Left Join corp_day_tbl Prod
ON Sales.locn_nbr IN (1597, . . . , 9456) AND

Sales.sku_id = Prod.sku_id′

Which is rewritten as (changes highlighted using bold text):

SEL SUM(sell_amt)

FROM (daily_sales_tbl Sales Left Join inlist1

ON Sales.locn_nbr = inlist1.locn_nbr)

Left join corp_day_tbl Prod

ON Sales.sku_id = Prod.sku_id AND

inlist1.locn_nbr IS NOT NULL;

The techniques outlined improve performance for general IN-list queries by extending the use of IN-List star join and IN-List access path techniques to situations where large IN-Lists on a non-index column are present. The technique is also capable of transforming an IN-List into an IN-List relation to simplify parsing on large IN-Lists. This in turn reduces memory usage, allowing IN-Lists with more values to be processed without increasing or overshooting available resources.

Typically, when an IN-List is evaluated as a qualification condition, all rows in a table have to be compared, in a worst case, with all values in the IN-List or, on average, with approximately half the values in the IN-List. The IN-List star join and IN-List access path techniques use an extra join to ameliorate the time consuming predicate evaluation. By utilizing any one of a number of join methods, the comparison per row can result in substantive reductions in processing overhead.

For example, a typical query may be:

SEL SUM(sell_amt)

FROM daily_sales_tbl Sales
WHERE Sales.locn_nbr IN (1597, 1598, . . ., 9456);

When utilizing the IN-List access method, the IN-List of values (1597, 1598, . . . , 9456) is inserted into a spool (Spl1). The spool is then joined to daily_sales_tb1 using following join condition:
Spl1.locn_nbr=daily_sales_tb1.locn_nbr

Where no index is available for the join between daily_sales_tb1 and the IN-List spool, advanced join methods such as “hash join on the fly” and “sort merge join”, when used in conjunction with spooling, can reduce the total CPU usage. For example, if hash join on the fly is used and the daily_sales_tb1 is accessed directly, then each row of the table is compared to each row of the left table that has the same hash. The number of comparisons against each row is:
#comparison per row=#join condition*#values in IN-list/#hash bucket

In most cases, the #join condition is 1 and # hash bucket is 65536, resulting in a noticeable gain in performance. Even where the processing overhead added by the joins, such as hash table, is taken into consideration, the overall performance gain is still significant.

Moreover, to extend In-List Star Join and In-List Access Method to large IN-Lists defined on non-index columns, the predicate analyzer of In-List Star Join and In-List Access Method can be modified to search qualified large IN-Lists on non-index columns and store them in IdxOrLists without being associated with any index. Therefore, in practice, for a group of IN-Lists associated without an index, In-List star join and In-List access method will have a similar CPU load to a group of IN-Lists that are associated with an index.

The text above described one or more specific embodiments of a broader invention. The invention also is carried out in a variety of alternative embodiments and thus is not limited to those described here. For example, while the invention has been described here in terms of a DBMS that uses a massively parallel processing (MPP) architecture, other types of database systems, including those that use a symmetric multiprocessing (SMP) architecture, are also useful in carrying out the invention. Many other embodiments are also within the scope of the following claims.

We claim:

1. A method for optimizing a SQL query, in which the SQL query includes a an IN-List query statement to access data in a table, where the method includes:
concluding that an IN-List exceeds a predetermined size;
removing the IN-List query statement; and
inserting a query which utilizes a join operation.

2. The method of claim 1 further including:
concluding that the IN-List query statement is located within a WHERE clause;
adding a join between the IN-List and the table; and
replacing the IN-List with a join condition in the WHERE clause.

3. The method of claim 2 further including:
concluding that the clause is an ON clause;
concluding that the join is to an inner table; and
inserting the join statement between the inner table and the IN-List query.

4. The method of claim 3 further including:
concluding that the join is to an outer table; and
replacing the IN-List with the new join condition.

5. The method of claim 1 further including:
concluding that no WHERE or ON clause exists; and
placing the IN-List in a spool so as to join the spool with the table.

6. A database system for accessing a database, the database system including:
a parallel processing system including one or more nodes and a plurality of CPUs, each of the one or more nodes providing access to one or more of the CPUs;
a plurality of virtual processes, each of the one or more CPUs providing access to one or more processes, where each process is configured to manage data stored in one of a plurality of data-storage facilities; and
an optimizer configured to optimize a plan for executing a query including an IN-List query statement to access data in a table, where the optimizer is configured to:
conclude that an IN-List exceeds a predetermined size;
remove the IN-List query statement; and
insert a rewritten query which utilizes a join operation.

7. The database system of claim 6 where the optimizer is configured to:
conclude the IN-List query statement is located within a WHERE clause;
add a join between the IN-List and the table; and
replace the IN-List with a join operation in the WHERE clause.

8. The database system of claim 7 where the optimizer is configured to:
conclude that the clause is an ON clause;
conclude that the join is to an inner table; and
insert the join condition between the inner table and the IN-List query.

9. The database system of claim 6 where the optimizer is configured to:
conclude that the join is to an outer table; and
replace the IN-List with the new join condition.

10. The database system of claim 6 where the optimizer is configured to:
conclude that no WHERE or ON clause exists; and
place the IN-List in a spool to join the spool with the table.

11. A computer program, stored on a tangible storage medium, for use in optimizing a query plan for executing a query to access data in a table, where the query includes an IN-LIST query statement, the program including executable instructions that cause a computer to:
conclude that the size of an IN-List exceeds a predetermined size;
remove the IN-List query statement; and
insert a rewritten query which includes a join operation.

12. The computer program of claim 11 including executable instructions that cause a computer to:
conclude that the IN-List query statement is located within a WHERE clause
add a join between the IN-List and the table; and
replace the IN-List with a join condition in the WHERE clause.

13. The computer program of claim 12 including executable instructions that cause a computer to:
conclude that the clause is an ON clause;
conclude that the join is to an inner table; and
insert the join condition between the inner table and the IN-List query.

14. The computer program of claim 13 including executable instructions that cause a computer to:
conclude that the join is to an outer table; and
replace the IN-List with the new join condition.

15. The computer program of claim 11 including executable instructions that cause a computer to:
conclude that no WHERE or ON clause exists; and
place the IN-List in a spool so as to join the spool with the table.
